(19) United States
(12) Patent Application Publication
(10) Pub. No.: US 2020/0126422 A1
(43) Pub. Date: Apr. 23, 2020

(54) Systems And Methods For Providing Communications From Automation To Third Parties

(71) Applicant: Richard J. Tummers, Calgary (CA)

(72) Inventor: Richard J. Tummers, Calgary (CA)

(21) Appl. No.: 16/661,075

(22) Filed: Oct. 23, 2019

Related U.S. Application Data
(60) Provisional application No. 62/749,471, filed on Oct. 23, 2018.

(51) Int. Cl. G08G 1/16; H04L 12/58; H04L 29/08

(52) U.S. Cl. CPC G08G 1/166; H04L 67/125; H04L 51/02

(57) ABSTRACT

A system is provided for providing communication from automation to third parties. The system is able to receiving data about the environment around the automation and to process this data into messaging to be communicated to the third party. A method is also provided for facilitating messaging from an automation to a third party. The present system provides means for third parties to better understand the awareness, actions or intended actions of an automation. The messaging facilitates assurance and safety to third parties moving, living and working around automation.

### FIELD OF INVENTION

The present invention relates to systems and methods for providing communication and messaging from a machine to a third party.

### BACKGROUND OF THE INVENTION

The term automation is used here collectively to encompass machines, robots, vehicles and various types of movement by automation.

Artificial intelligence (AI), machine learning, neural networks and other similar technologies have paved the way for extensive use of automated machines and robots that move and perform tasks independently without constant or direct operator input. Such automation is typically fitted with sensors to detect the environment around the automation, and processors to take environmental information, make decisions and take actions based on those decisions.

Such AI robots and machines are used extensively in manufacturing, and are quickly being used more and more in more public spaces.

Autonomous vehicles are one important example of automation being used in public spaces. Autonomous vehicles take in data on location, traffic, traffic signals and road conditions around them and process this information to make driving decisions.

U.S. Pat. No. 7,317,406 teaches the use of AI in traffic signals to analyze a situation with multiple vehicles and displays signaling based on situation.

U.S. Pat. No. 6,668,219 teaches an AI device in an automobile to diagnose any malfunction of the automobile and display the results to the driver.

One challenge with automated machines and robots and autonomous vehicles is that third parties near automation, cannot “read a machine's mind.” While the automation may be aware of its surroundings and make decisions based on that information, it is impossible for a third party to know what those decisions might be. This adds significant risk to third parties near automation.

This problem can also present itself in the interaction of manned machines, for example in the interaction of manned cars with pedestrians, cyclists, other manned vehicles. Sometimes the driver and the pedestrian/cyclist/manned vehicle may use eye contact, visual signals, audio or verbal communication to relay what next actions either the vehicle or the pedestrian/cyclist will take and ensure the permission of the other to take those actions. However, in many cases, communication fails, eye contact is not made, and it is not clear who will proceed and who will yield right of way. In such circumstances accidents are inevitable.

There is therefore a need to provide means for communicating the actions and intended actions of an automation to third parties such that third parties can live and work safely around automation.

### SUMMARY

A system is presented for providing communication from an automation to a third party. The system comprises a system processor; a messaging platform for communicating data from the system processor; and a memory that stores instructions. The instructions, when executed by the system processor, cause the processor to perform operations comprising receiving data; processing data to determine messaging to be delivered to the third party based on data; and communicating, via the messaging platform, the messaging to the third party.

A messaging system is further provided for facilitating messaging from an automation to a third party. The system comprises a messaging platform for receiving data and instructions from an automation processor and communicating messages from the automation to the third party.

A method is also provided for facilitating messaging from an automation to a third party. The method comprises the steps of receiving information selected from the group consisting of information on what the automation is aware of around it, what next steps the automation is taking, the automation's intended actions, the automations' awareness of the third party and any combination thereof, processing messages based on the information received; and communicating messaging to the third party.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

A further, detailed, description of the invention, briefly described above, will follow by reference to the following drawings of specific embodiments of the invention. The drawings depict only typical embodiments of the invention and are therefore not to be considered limiting of its scope. In the drawings:

FIG. 1A is a schematic diagram of one example of the present system;

FIG. 1B is a schematic diagram of a further example of the present system;

FIG. 1C is a schematic diagram of a further example of the present system;

FIG. 1D is a schematic diagram of a further example of the present system;

FIG. 1E is a schematic diagram of a further example of the present system;

FIG. 2A is a perspective view of one embodiment of the present invention, for use on front and side surfaces of a vehicle;

FIG. 2B is a perspective view of a further embodiment of the present invention, for use on a rear surface of a vehicle

FIG. 3a is a perspective view of a further embodiment of the present invention, for use with a travelling machine or robot;

FIG. 3b is a perspective view of a further embodiment of the present invention for use with moving robotic device;

FIG. 4 is a perspective view of a further embodiment of the present invention for use with a stationary robotic device; and

FIG. 5 is a perspective view of a further embodiment of the present invention for use on a drone.

The drawings are not necessarily to scale and in some instances proportions may have been exaggerated in order to more clearly depict certain features.

### DETAILED DESCRIPTION OF VARIOUS EMBODIMENTS

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects.

The present invention provides a system and means for third parties to better understand the awareness, actions or intended actions of an automation or machine. For the purposes of the present invention a third party can include any people near automation.

In one aspect the present invention provides a novel system and method for data visualization and data communication.

The present description includes methods for providing messaging to third parties. The messaging can include information about the awareness, actions and intended actions of the automation.

The open messaging of the awareness and intended actions of automation will help third parties to be aware of the actions of automation in their surroundings.

For the purposes of the present invention, the terms automation is considered to encompass machines, robots and vehicles. The term vehicle is used to encompass cars and other means of transportation such as trains, light rail, buses, planes, drones, cars, trucks and autonomous ships, among others. The automation can be autonomous or can be operator controlled. The automation can use artificial intelligence. Some machines and robots may move, others may have a stationary base.

In some cases, messaging is provided from or on an exterior of the automation. The messaging can be visual, audio or both.

In other embodiments, messaging may be communicated to the third party by sending message to a third party device. In such cases the messaging can sent to third party device by WiFi, radio, Bluetooth, or other broadcasting technology. The third party device can include a PC, tablet, phone, headphones, pda, laptop, smartphone and other similar devices, and can optionally be transmitted to an application installed on the device. In one example, data on autonomous or driver operated public transportation can be communicated by the present system via an app on a smart phone.

The communication and messaging can aid third parties to better understand how automation will move or act, which in turn can improve the third party's trust and comfort in working around such automation. Safety of third parties can also be greatly improved.

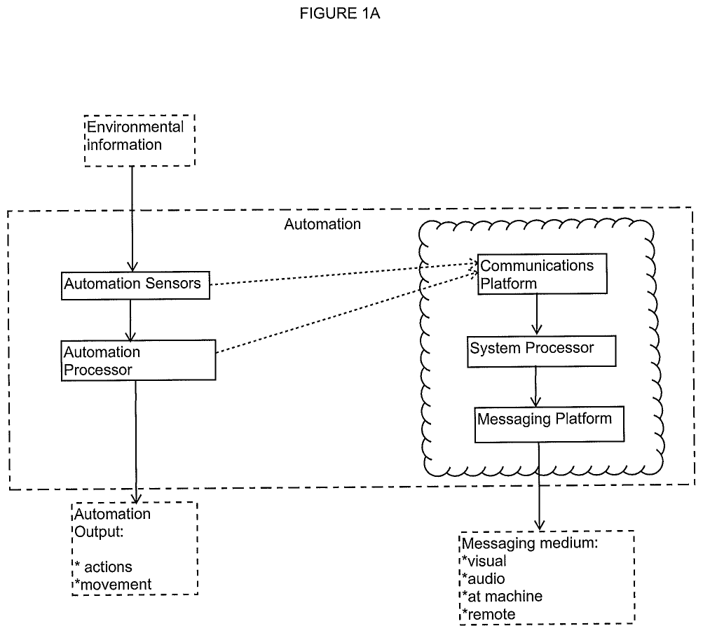

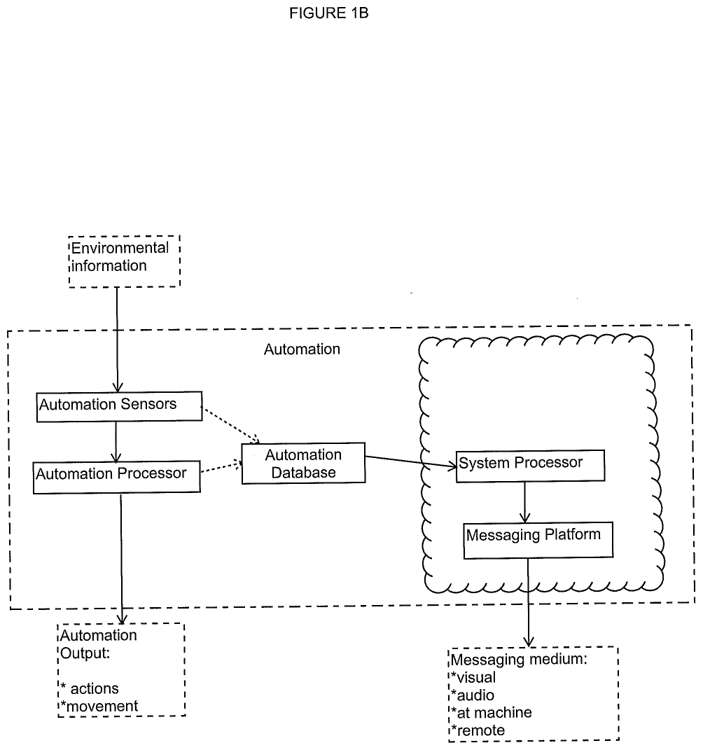

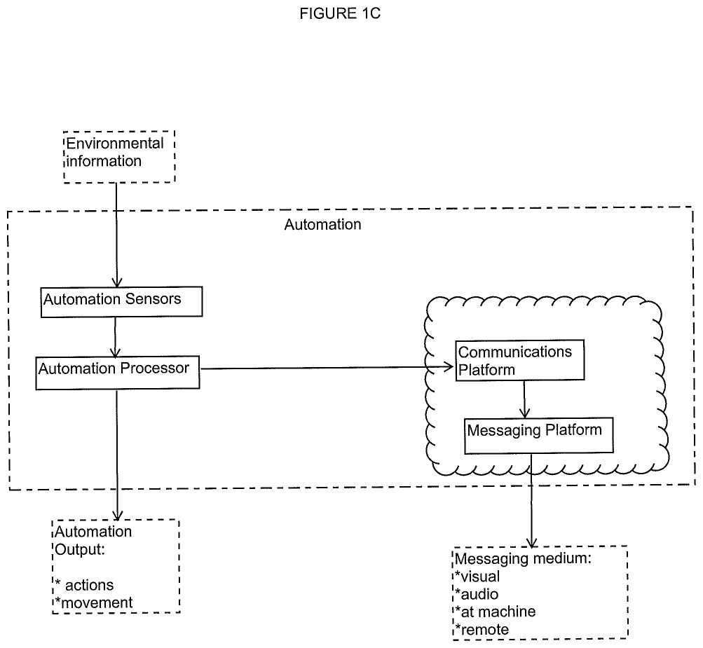

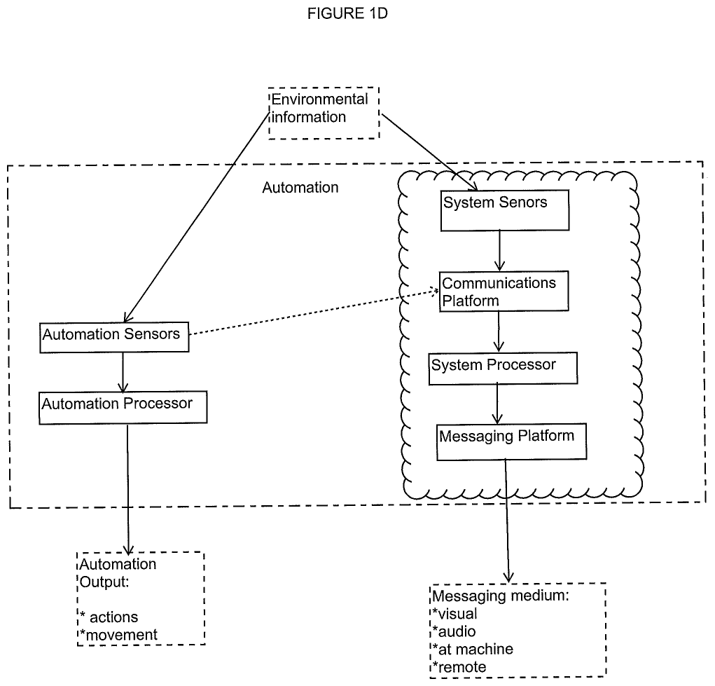

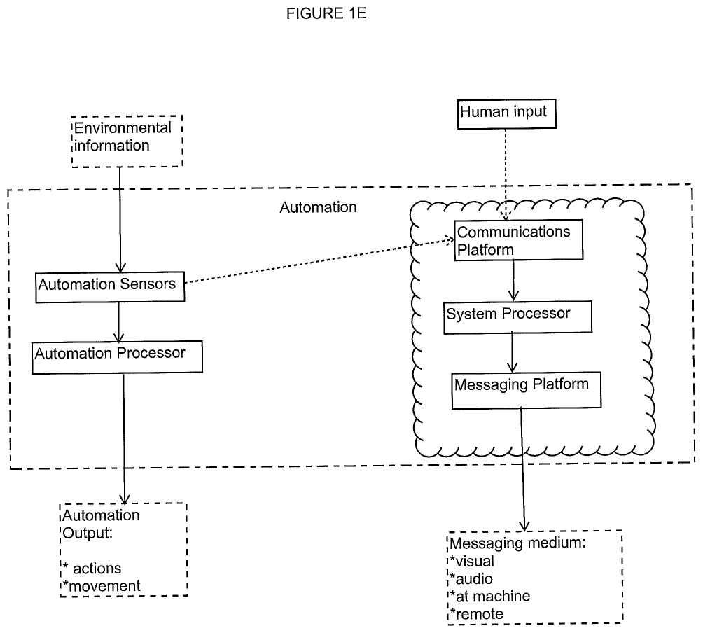

In some embodiments, as illustrated in FIG. 1A, the present system collects data from the automation's sensors or processor, which data relates to environmental information collected by the automation and actions or intended actions of the automation. The present system then processes that data to determine the messaging to be delivered to third parties and communicates that data to third parties. The system is identified by the cloud. The dashed arrow indicates that information or data may or may not be transferred between the source and destination of such arrows.

In some cases, as with vehicles, the automation processor is, for example, an electronic control unit (ECU). In some embodiments, the present invention may be implemented as an ECU to integrate with other technology.

In a further embodiment, as illustrated in FIG. 1B, data from the automation's processor or sensors is stored in a database of the automation, from which the system processor can collect information at pre-determined intervals, or continuously, to then process the data and determine messaging.

In other embodiments, as illustrated for example in FIG. 1C, the automation's processor may determine the messaging and the present system collects and then delivers the messaging data to the third party. The system is again identified by the cloud.

As illustrated in FIG. 1D, the present system itself may include system sensors by which the system collects data. In such cases data from the automation's sensors may or may not also be fed into the current system. The system is again identified by the cloud.

FIG. 1E illustrates a further embodiment of the present system and methods. The system is again identified by the cloud. In this embodiment, the present system collects data directly from the automation sensors, without requiring that such data be processed by the machine processor. The automation sensor data, together with optional data from system sensors, as illustrated in FIG. 1D, is then processed directly by the system processor and communicated in the form of messaging.

In a further embodiment illustrated in FIG. 1E, data can be provided to the system by human input, such as local or remote operator input or driver input.

In all embodiments, a memory may be associated with the system or automation processor for performing steps.

The data collected by the automation or by the system can include information about the environment around the automation picked up by one or more automation and system sensors. This could also include recognition of the presence of a third party by the automation. The data used by the present system can also include the decisions made by automation processor, actions or intended actions to be taken by automation.

Messaging to a third party may provide information on what the automation or system sensors are aware of around it, what actions the automation will take, automation's intended actions and also the automation's awareness of the third party. It may simply make the third party aware of what the automation will do next or what it sees or senses. However, the messaging to third party may also comprise instructions to the third party based on the automation's awareness and intended actions. As such the system not only messages what the automation is doing, but also what the third party should or should not do based on the automation's intended actions.

By providing messaging between an AI and a third party a means of data communication is established. The inventor commercially refers to this system as AI2Eye™ or AI2Hear™.

In one example, the messaging provided by the present system can inform a third party that it is safe to walk, move, or cross the path of the automation.

Messaging provided by the present system can inform the third party about environmental factors that are within sensing range of automation but might not yet be seen or heard or realized by the third party. An example of this could be messaging to a pedestrian not only about the vehicle using the current system, but also about the movement of other nearby vehicles that the third party cannot yet see but whose movements have been detected by the vehicle using the present system.

By providing messaging of the automation's awareness or intended actions, accidents involving automation can be somewhat reduced. For example automation sensors do not always sense everything needed by the automation processor to determine next actions, or if the automation processor does not calculate a safe intended action due to errors in data or algorithms. In such cases, the messaging of the automation's actions or intended actions can alert a third party to unexpected or erroneous behavior of the automation, including alerting the third party that the automation has not sensed the presence of the third party.

In some instances, the systems of the present invention can be incorporated into automation that is being tested or repaired, to readily and easily message to anyone in the room if the automation is working properly.

The present system can also be incorporated into manned vehicles and human operated machinery, to provide more insight to third parties about the actions or movements of the automation, for example if the driver or operator cannot be seen, or if the driver is incapacitated.

The medium of messaging provided can be either visual or audio or both. Messaging is preferably at least somewhat specific and descriptive to ensure that the third party understands that the message is being directed to them and what the content of the message is. In audio messaging, verbal messaging is preferred, although non-verbal messaging such as beeps, bells or sirens can be used, together or separate to verbal messaging.

Visual messaging relayed by the present system preferably comprises text and pictorial messaging, although commonly understood symbols such as a red octagon for stop, or a yellow triangle for hazard or green lights or arrows can also be used. Text has the advantage of conveying a more specific message with words in a local language that could otherwise be lost in symbolic or pictorial visual messaging.

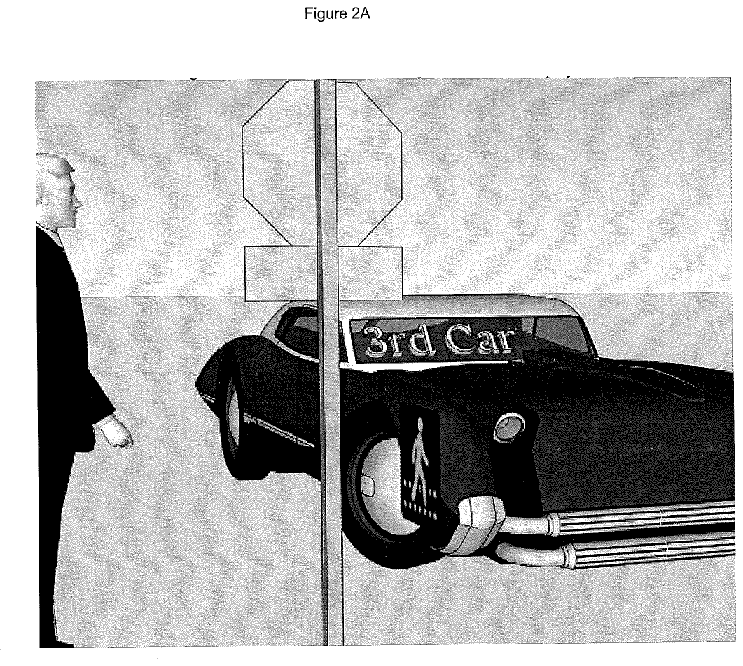

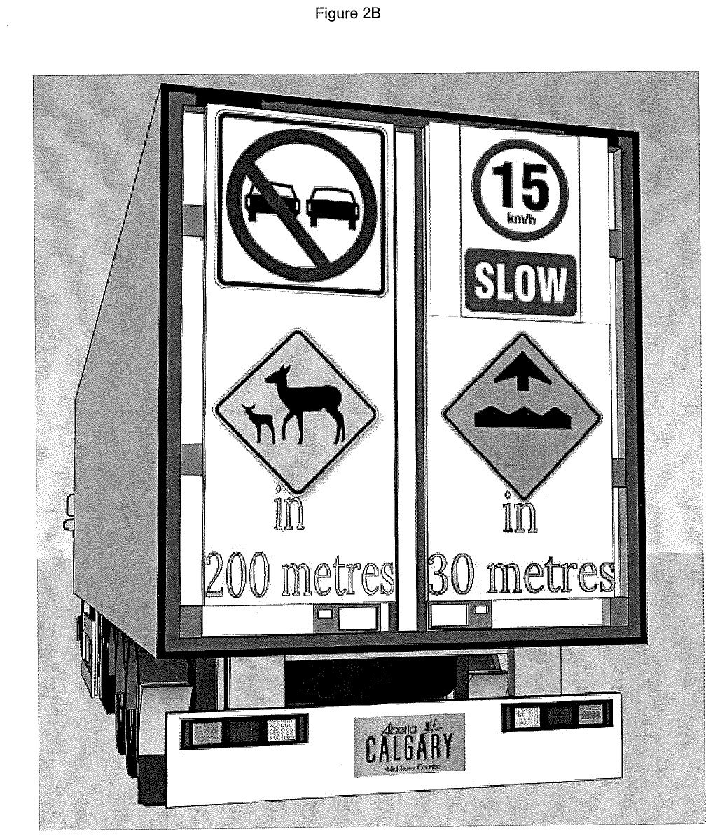

FIG. 2 illustrates an example of the use of the current invention on a vehicle that can be a manned vehicle or an autonomous vehicle. In this particular example, the front windshield has been enhanced to display visual messaging, more particularly, to indicate that it is the 3^{rd} car to stop at a 4-way stop sign. The vehicle in this example also has a side messaging display indicating to the pedestrian that the car will remain stopped and that the pedestrian may proceed. The vehicle could optionally also use a yellow warning colour that changes to a red stop sign and a message of “Accelerating” to indicate when the vehicle intends to accelerate. The messaging conveyed by the system communicates that the sensors have detected the pedestrian, and are giving it a clear signal that it is safe to cross.

It is also possible for the vehicle to have messaging displayed on the back windshield for messaging vehicles or third parties who are behind the vehicle.

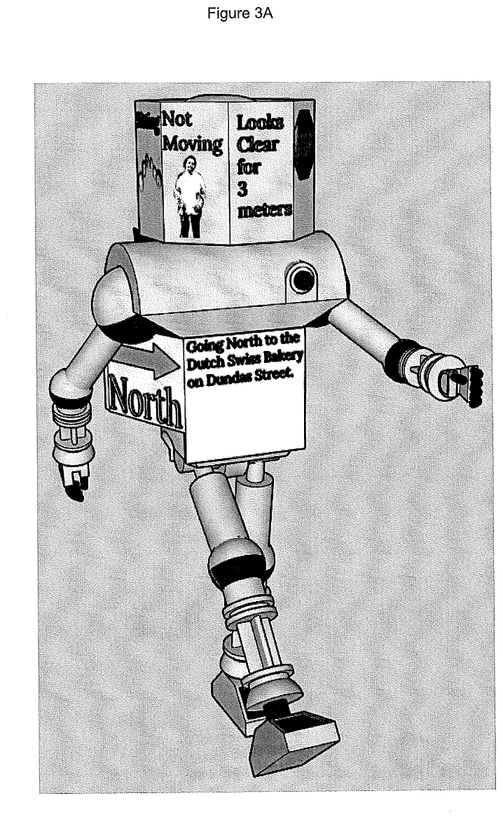

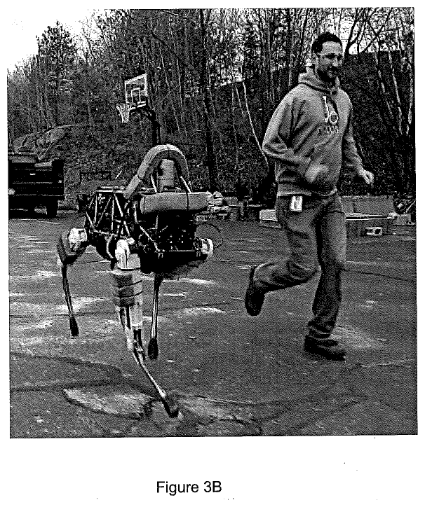

FIGS. 3a and 3b illustrate examples of the use of the present system to improve safety around a walking robot. It is configured to deliver and display messaging around the head of robot and also facing front and back. In this embodiment, the robot takes in data about third parties around them, in particular photographs, and the system produces messaging that displays both the photograph of the third party and the current moving status of the third party such as “sitting” “standing”, “not moving” walking” etc. This messaging allows third parties to understand that they have (or have not) been detected by the robot and what the robot perceives that third party to be doing. Should, for example a third party be moving and notice the system displaying messaging to indicate that the robot detects the third party to not be moving, then the third party will realize that the robot might not expect the third party to come into the path of the robot. If a slow moving third party notices the system displayed messaging that indicates it has detected a fast moving bicycle, then the third party can adjust their behavior knowing that the robot is not planning to slow or stop. The robot has incorrectly calculated they will quickly be out of the direction of travel.

The present system may also provide, in the case of vehicles or travelling automation, messaging to indicate the destination, course and direction of travel of the automation. Such information can be useful to provide third parties with more knowledge about likely changes in direction by the automation. Speed of travel may also be indicated, as well as rate of acceleration or deceleration, which can be useful when displayed on a rear facing display of any automation.

While vehicles currently come with a number of standard signals such as reverse lights, brake lights, turn signals and hazard signals, further and more detailed messaging to other vehicles or third parties behind the vehicle can minimize accidents. For example, the current system can process and convey messaging about the current and upcoming speed of the vehicle, possible reasons ahead for changes in acceleration or speed such as approaching accidents, construction, pedestrians, school zones or emergency vehicles. In a further preferred embodiment, the present system can manipulate the positioning of messaging on a machine or vehicle to depict movement of objects such as showing movement of a pedestrian, cyclist or animal from left to right across the front of the vehicle.

FIG. 2b shows an embodiment of the present system using displays covering a rear surface of a truck. In FIG. 2b, the top left of the display is used to show a “No Passing” symbol. The top right of the display shows that the intended speed is 15 km/h. The bottom right of the display shows one reason for slow speed being a construction zone 30 m ahead. The bottom left of the display shows another reason for low speed being deer have been detected within 300 m. An important use of rear messaging is to warn other vehicles and automation of upcoming school zones.

The current system can use the displays to ensure that the position normally used for the red Tail Lamps, Brake Lights, Emergency Stop Signals, Rear Fog Lamps, Backup Lamps, Centre High Mount Stop Lamp and Hazard Flashers would be coloured the correct shades and intensities as required by local legislation.

The Rear Registration Plate Numbers is shown in FIG. 2 as also forming a display. Messaging directed to the front face of a machine or automation can display real time information about the awareness and intentions of the automation to third parties ahead of any forward motion. The messaging can also be directed to oncoming traffic or vehicles. The current system can also provide warning messaging more precisely than current techniques, in vehicles for example, such as honking the horn, or headlight flashing.

In one example the present system may sense and then deliver messaging to oncoming vehicles about unsafe actions of the oncoming vehicle such as travelling in the wrong direction on a one way street. Alternatively, the present system may sense, process and then convey messaging to oncoming vehicles about issues in the oncoming vehicle such as headlights being turned off or broken.

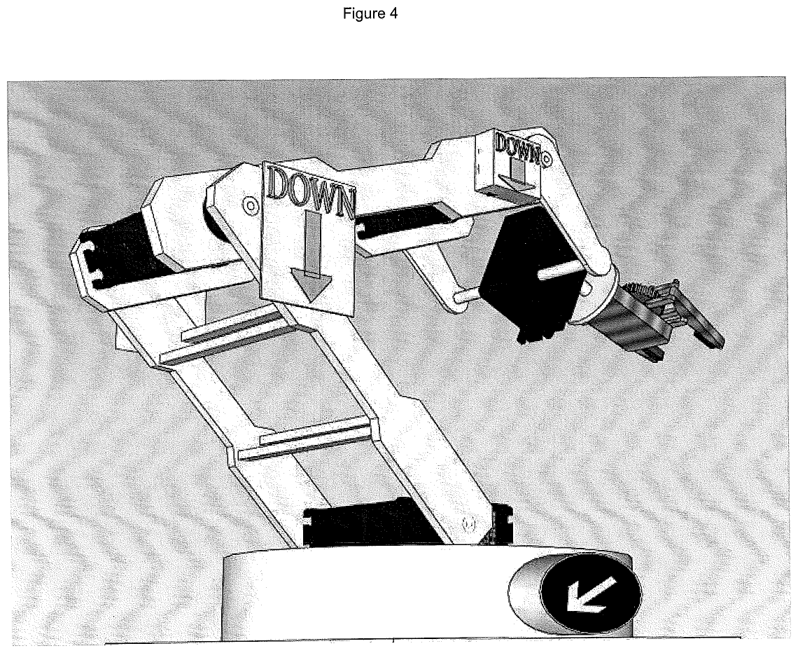

FIG. 4 illustrate further use of the present invention on industrial robots.

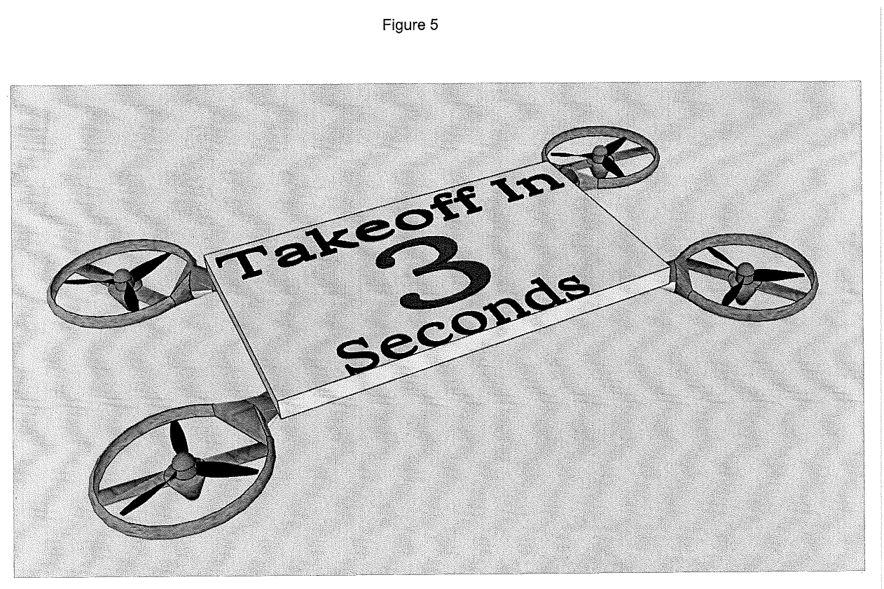

FIG. 5 illustrates an example the use of the current invention on a flying drone with a single display facing that can be effectively used to improve the safety of third parties during takeoff.

The type of display technology used will vary with the type of automation, the environment in which it operates and the third parties or third parties it may come into contact with. For machines and robots, standard light-emitting diode display (LED), electroluminescent display (ELD), liquid crystal display (LCD), organic light-emitting diode display (OLED), digital light processing display (DLP), and any others known by those in the art may be used to display messaging generated and communicated by the current system.

Display screens can be flat, curved or flexible. The displays can be made of a number of materials and can be all-weather rated for outside use. Transparent display screens could be used to replace glass in existing vehicles (organic LED, resonant nano-particle scattering, and other technologies are some examples).

Exterior display screens can be located anywhere on a moving machine, including the use of transparent display screens to replace windows, windshields, mirrors, lights, body parts.

Displays can be permanent or temporary and displays can be modular such that they are removable and applicable to different parts of an automation.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A system for providing communication from an automation to a third party, said system comprising:
a) a system processor;
b) a messaging platform for communicating data from the system processor; and
c) a memory that stores instructions, wherein said instructions, when executed by the system processor, cause the processor to perform operations comprising:
i. receiving data;
ii. processing data to determine messaging to be delivered to the third party based on data; and
iii. communicating, via the messaging platform, the messaging to the third party.

2. The system of claim 1 wherein data is received from any one or more of automation sensors, system sensors, human input and an automation processor.

3. The system of claim 2 further comprises a communications platform for communicating with any one or more of the automation sensors, the system sensors and the automation processor and wherein receiving data comprises receiving said data via said communications platform.

4. The system of claim 2, wherein data from any one or more of the automation sensors and the automation processor is stored in an automation database from where it is collected by the system processor.

5. The system of claim 1, wherein the automation is vehicle.

6. The system of claim 5, wherein the vehicle is autonomous.

7. The system of claim 5, wherein the vehicle is non-autonomous.

8. The system of claim 1, wherein the automation is a robot.

9. The system of claim 8, wherein the robot is an artificial intelligence (AI) robot.

10. The system of claim 9, wherein the AI robot is a moving robot.

11. The system of claim 9, wherein the AI robot is stationary.

12. The system of claim 1, wherein messaging is provided from or on an exterior surface of the automation.

13. The system of claim 12, wherein the messaging is visual or audio or both.

14. The system of claim 1, wherein messaging is communicated to the third party by sending a message to a third party device.

15. The system of claim 14, wherein messaging is sent to the third party device by WiFi, radio, Bluetooth, or other broadcasting technology.

16. The system of claim 14, wherein the third party device is PC, tablet, phone, smart phone, headphones, pda and laptop.

17. The system of claim 1, wherein the third party is one or more bystanders, pedestrians, operators, nearby people, pets and drivers of other vehicles.

18. The system of claim 1, wherein the data is selected from the group consisting of information about the environment collected by one or more automation sensors or one or more system sensors, information about the automation, decisions made by automation processor and actions or intended actions to be taken by automation.

19. The system of claim 18, wherein the data includes recognition of the presence of third party by the automation.

20. The system of claim 1, wherein messaging to third party provides information on what the automation is aware of around it, what actions the automation will take, automation's intended actions, the automation's awareness of the third party

21. The system of claim 20, wherein the messaging to third party comprises instructions to the third party based on the automation's awareness and intended actions.

22. The system of claim 21, wherein the messaging informs third party it's safe to walk/move/cross the path of the automation.

23. The system of claim 20, wherein the messaging provides information to third party that is within sensing range of automation but not within sensing range of third party.

24. The system of claim 20, wherein the messaging is about errors in operation of automation.

25. A messaging system for facilitating messaging from an automation to a third party, said system comprising:
a. a messaging platform for receiving data and instructions from an automation processor and communicating messages from the automation to the third party.

26. A method of facilitating messaging from an automation to a third party, said method comprising steps of:
a. receiving information selected from the group consisting of information on what the automation is aware of around it, what actions the automation will take, the automation's intended actions, the automations' awareness of the third party and any combination thereof;
b. processing messages based on the information received; and
c. communicating messaging to the third party.
